(19) United States
(12) Patent Application Publication
(10) Pub. No.: US 2004/0057748 A1
(43) Pub. Date: Mar. 25, 2004

(54) Image-recorded medium

(75) Inventors: Naoyuki Egusa, Ashigarakami-gun (JP); Tetsuro Kodera, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/660,615

(22) Filed: Sep. 12, 2003

(30) Foreign Application Priority Data
Sep. 19, 2002 (JP) 2002-273806

(51) Int. Cl. G03G 15/00

(52) U.S. Cl. 399/107

(57) ABSTRACT

The present invention relates to an image-recorded medium in which on a surface of a transparent substrate, a plurality of toner layers are electrophotographically laminated and fixed, and thereby a fixed image is formed, wherein among melting temperatures of the toners constituting the respective layers of the plurality of toner layers, a melting temperature of a toner that constitutes at least an outermost toner layer is the highest.

### CROSS-REFERENCE TO RELATED APPLICATION

This application claims priority under 35 USC 119 from Japanese patent Application No. 2002-273806, the disclosure of which is incorporated by reference herein.

### BACKGROUND OF THE INVENTION

1. Field of the Invention

The present invention relates to an image-recorded medium on which a recording image visible with both of reflection light and transmitting light is formed.

2. Description of the Related Art

In recent years, improvement in the image quality of OHP sheets is strongly demanded in relation to a demand for an improvement in color image quality.

In order to cope with the demand for an improvement in the image quality of the OHP sheet, the image quality thereof has to be evaluated with both of reflection light and transmitting light. In the case of the OHP sheet being evaluated with the transmitting light, both characteristics of the screening property and the transmitting property of light are demanded in a formed image portion.

However, when a standard process of electrophotography is used without modification, not only the screening property of light cannot be secured but also there is a problem in that a lot of holes called pinhole that allow light transmitting are formed.

In order to solve the problem and to apply the process of electrophotography, the following two countermeasures are indispensable.

(1) Increasing a transferred mass per unit area (TMA) of toner in a light screening portion as much as possible.

(2) Increasing black toner in the light screening portion as much as possible.

According to the two countermeasures, the shielding properties of light can be secured. However, since the TMA is higher than that in an ordinary system, when the ordinary system is used without modification, problems such as transfer defect, image destruction due to bubbling at fixing called blister and the like are caused; accordingly, sufficient image quality cannot be obtained. That is, these transfer defect and blister, when a recorded image is evaluated with transmitting light, causes defects called pinholes.

### SUMMARY OF THE INVENTION

The present invention intends to solve the problems accompanying the existing process.

That is, an object of the invention provides, in the field of OHP sheets or the like for which higher image quality is demanded, an image-recorded medium having a recorded image high in the reliability.

The problems can be overcome owing to the following aspects of the invention. That is, The first aspect of the invention is to provide an image-recorded medium (S) comprising a fixed image obtained by electrophotographically laminating a plurality of toner layers on a transparent substrate and fixing the plurality of toner layers, wherein a toner constituting at least an outermost toner layer has the highest melting temperature among toners constituting the respective layers of the plurality of toner layers.

The second aspect of the invention is to provide the image-recorded medium (S), wherein the lowest melting temperature among the toners constituting the respective layers of the plurality of toner layers is at least 80° C.

The third aspect of the invention is to provide the image-recorded medium (S), wherein the plurality of toner layers includes two layers of K (black) colored toner.

The fourth aspect of the invention is to provide the image-recorded medium (S), wherein the plurality of toner layers includes a K (black) colored toner layer, and a black toner in the K colored toner layer contains 4 to 15% by mass of carbon black and has a TMA of 1.2 to 2.0 mg/cm².

The fifth aspect of the invention is to provide the image-recorded medium (S), wherein each of the plurality of toner layers includes a carrier having a particle diameter of 20 to 100 μm and the toner, and a ratio of a mass of the toner to a total mass of the carrier and the toner is from 2 to 12%.

The sixth aspect of the invention is to provide the image-recorded medium (S), wherein a TMA of the toners on a surface of the substrate is from 0.3 to 1.0 mg/cm².

The seventh aspect of the invention provides the image-recorded medium (S), wherein the plurality of toner layers includes toner layers of magenta color, yellow color, cyan color and white color, and the respective toner layers each include toners comprising 4 to 40% by mass of a coloring agent.

The eighth aspect of the invention provides the image-recorded medium (S), wherein a difference between melting temperature of the toner of the outermost toner layer and the melting temperatures of toners of other layer having different melting temperatures are from 5 to 30° C.

The ninth aspect of the invention provides the image-recorded medium (S), wherein a difference between melting temperature of the toner of the outermost toner layer and the melting temperatures of toners of other layer having different melting temperatures are from 5 to 30° C., and the lowest melting temperature of the toners each constituting one of the plurality of toner layers is at least 80° C.

The tenth aspect of the invention is to provide an image-recorded medium (T), comprising a fixed image obtained by electrophotographically laminating a plurality of toner layers on a transparent substrate and fixing the plurality of toner layers, wherein a melting temperature of the toner constituting each of the plurality of toner layers sequentially increases from a first layer formed on a surface of the substrate toward the outermost toner layer.

The eleventh aspect of the invention provides the image-recorded medium (T), wherein the lowest melting temperature of the toners constituting the respective layers of the plurality of toner layers is at least 80° C.

The twelfth aspect of the invention provides the image-recorded medium (T), wherein the plurality of toner layers includes two layers of K (black) colored toner.

The thirteenth aspect of the invention provides the image-recorded medium (T), wherein the plurality of toner layers includes a K (black) colored toner layer, and a black toner in the K colored toner layer contains 4 to 15% by mass of carbon black and has a TMA of 1.2 to 2.0 mg/cm².

The fourteenth aspect of the invention provides the image-recorded medium (T), wherein each of the plurality of toner layers includes a carrier having a particle diameter of 20 to 100 μm and the toner, and a ratio of a mass of the toner to a total mass of the carrier and the toner is from 2 to 12%.

The fifteenth aspect of the invention provides the image-recorded medium (T), wherein a TMA on a surface of the substrate is from 0.3 to 1.0 mg/cm².

The sixteenth aspect of the invention provides the image-recorded medium (T), wherein the plurality of toner layers includes toner layers of magenta color, yellow color, cyan color and white color, and the respective toner layers each include a toner comprising 4 to 40% by mass of a coloring agent.

The seventeenth aspect of the invention provides the image-recorded medium (T), wherein a difference between a melting temperature of the toner of the outermost toner layer and the melting temperatures of toners of other layers having different melting temperatures are from 5 to 30° C.

The eighteenth aspect of the invention provides the image-recorded medium (T), wherein a difference between a melting temperature of the toner of the outermost toner layer and the melting temperatures of toners of other layers having different melting temperatures are from 5 to 30° C., and the lowest melting temperature of the toners each constituting one of the plurality of toner layers is at least 80° C.

### BRIEF DESCRIPTION OF THE DRAWINGS

FIG. 1 is a constitutional sectional view showing an example of an image-recorded medium according to the present invention.

FIG. 2 is a schematic diagram showing a manufacturing process of the image-recorded medium.

FIG. 3 is a schematic sectional view showing an example of a plurality of toner layers before a fixing process is applied.

FIG. 4 is a schematic sectional view showing another example of a plurality of toner layers before a fixing process is applied.

FIG. 5 is a diagram showing temperature characteristics of melting viscosity of a toner.

### DETAILED DESCRIPTION OF THE INVENTION

In the following, the present invention will be detailed.

An image-recorded medium according to the invention is an image-recorded medium in which on a surface of a transparent substrate, according to an electrophotographic process, a plurality of toner layers are laminated and fixed and thereby a fixed image is formed, wherein among melting temperatures of the toners constituting the respective layers of the plurality of toner layers, a melting temperature of a toner that constitutes at least the outermost toner layer is the highest.

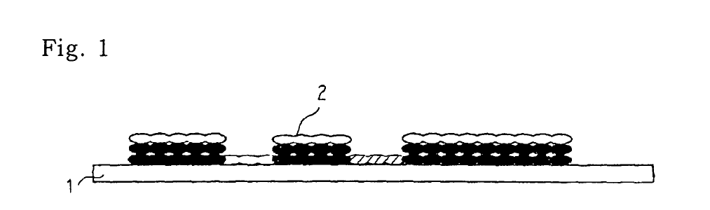

FIG. 1 is an enlarged sectional view showing an example of an image-recorded medium according to the invention. As shown in FIG. 1, the image-recorded medium includes a substrate 1 and a fixed image 2 fixed on a surface thereof.

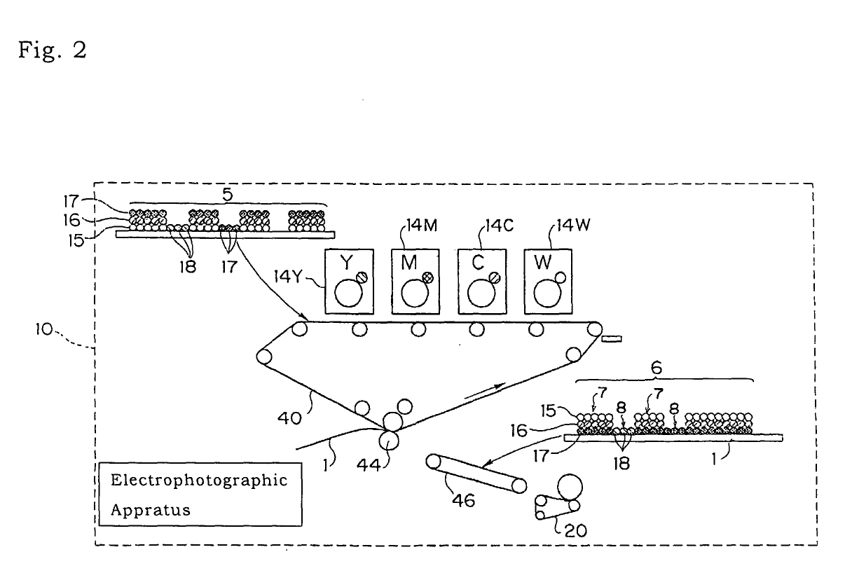

FIG. 2 shows an outline of a flow of manufacturing steps of an image-recorded medium according to the invention.

By use of electrophotography apparatus (image forming apparatus) 10, on a surface of the substrate 1 a plurality of toner layers are formed (step of toner layer formation) and fixed by use of a fixing unit 20.

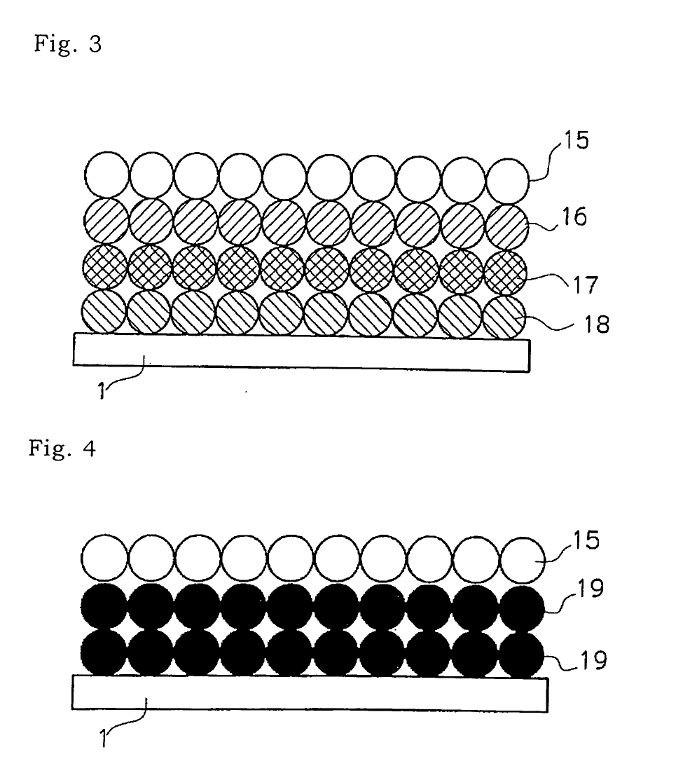

FIGS. 3 and 4 show enlarged sectional views of a plurality of toner layers laminated on a surface of the substrate 1 in the image forming apparatus 10 before the fixing. In FIG. 3, the outermost layer is a white (W) toner layer 15, downward thereof in the figure the toner layers of the respective colors of a C (cyan) toner layer 16, an M (magenta) toner layer 17 and a Y (yellow) toner layer 18 are successively laminated. In addition, in FIG. 4, below a white (W) toner layer 15 that is the outermost layer in the drawing, two layers of k (black) toner layers 19 made of the same toner are laminated.

In the invention, a melting temperature of a toner constituting at least the outermost toner layer has to be the highest among melting temperatures of the toners constituting the respective layers of the plurality of toner layers. When the plurality of toner layers has such a constitution, at the time of fixing in the image forming apparatus 10, the outermost toner layer does not melt before the other toner layers closer to the substrate 1 than the outermost toner layer melt. Accordingly, the toner layers closer to the substrate 1 are not covered with a molten toner of the outermost layer before the toner layers closer to the substrate 1 are melted. Accordingly, when the plurality of toner layers is fixed, air in gaps inside of the toner layers can be efficiently removed. As a result, the occurrence of blister is suppressed and thereby the image quality can be improved.

From the above viewpoint, in the invention, it is only necessary that of the plurality of toner layers, a melting temperature of a toner constituting at least the outermost layer is the highest. For instance, in all other layers than the outermost surface layer, the melting temperatures of the toners may be the same, or a toner layer having the same melting temperature as that of the outermost toner layer may be included as a layer in any one of lower layers.

Furthermore, in the plurality of toner layers formed on a surface of the substrate 1 in the invention, the plurality of toner layers is preferably laminated in such a manner that the melting temperature of the toner constituting each layer successively increases from a first layer formed on a surface of the substrate 1 toward a toner layer at the outermost layer.

That is, when the respective melting temperatures of the Y (yellow) toner, M (magenta) toner, C (cyan) toner and W (white) toner are represented by Tmy, Tmm, Tmc and Tmw, in a layer configuration shown in FIG. 3, the melting temperature of the toner constituting each toner layer preferably successively increases in the order of Tmy<Tmm<Tmc<Tmw.

When the plurality of toner layers are laminated in such a manner, in a fixing step described later, the toner layers melt successively from a toner layer closer to the substrate 1. Accordingly, air in the toner layers can be further efficiently removed, resulting in no generation of the blister and in an improvement in the image quality.

The “melting temperature of a toner” used in the specification means a temperature where the melting viscosity thereof becomes 10⁴ Pa·s when a flow test is carried out by use of a flow tester CTF-500 (manufacture by Shimadzu Corp.) with a die of a nozzle diameter of 1 mm and a length of 1 mm under the conditions of cylinder pressure of 9.8×10⁵ Pa and temperature rise rate of 3° C./min.

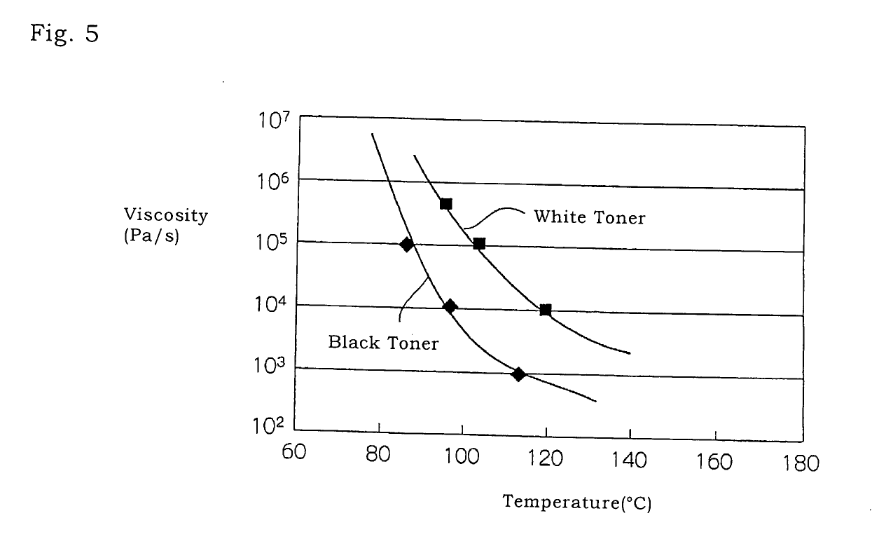

FIG. 5 shows the temperature characteristics of the melt viscosities of the W (white) toner and K (black) toner that constitute the plurality of toner layers shown in FIG. 4. As shown in FIG. 5, there is difference between melting viscosity curves of the W toner and the K toner; that is, while a temperature where the melting viscosity becomes 10⁴ Pa·s is in the neighborhood of 120° C. in the case of the W toner, it is in the neighborhood of 95° C. in the case of the K toner.

In the invention, with respect to the temperature where the melting viscosity becomes 10⁴ Pa·s, the difference of the melting temperatures between the toner of the outermost layer and that of other layers having different melting temperature from the melting temperature of the toner of the outermost layer, is preferably in the range of from 5 to 30° C., and more preferably in the range of from 10 to 20° C.

Furthermore, when the plurality of toner layers is laminated in such a manner that the melting temperature of the toner increases successively from the first layer on the surface of the substrate 1, the difference of the melting temperatures of the toners constituting toner layers contacting with each other in the plurality of toner layers is preferably in the range of 5 to 30° C., and more preferably from 10 to 20° C.

When the difference of the melting temperatures of the toners is less than 5° C., during fixing, in some cases, the toner of the outermost layer and the toners of the other layers, or the toners of the contacting toner layers may simultaneously melt. On the contrary, when the difference of the melting temperatures exceeds 30° C., in some cases, the toner layer distant from the surface of the substrate 1 including the outermost layer cannot be sufficiently fixed.

Furthermore, among the melting temperatures of the toners constituting the respective toner layers, the lowest melting temperature is preferably higher than the highest temperature possible at which the image-recorded medium of the invention is used as a part. When the lowest melting temperature is less than the heat resistance temperature, in some cases, images may flow when the image-recorded medium is used as a part.

Accordingly, for instance, when the image-recorded medium according to the invention is used as a display panel for use in home appliance, the lowest toner melting temperature is preferably no less than 80° C. or higher, and more preferably 90° C. or higher.

The substrate 1 that can be used in the image-recorded medium according to the invention has to be transparent. Here, the term “transparent” means the property that allows transmitting, for instance, light in the visible light region to some extent. According to the invention, such a transparency of the substrate 1 that a formed image can be seen through the substrate 1 with the naked eye is enough.

Plastic films are typically used as the substrate 1. These include light transmitting films usable for OHP such as an acetate film, a cellulose triacetate film, nylon film, polyester film, polycarbonate film, polystyrene film, polyphenylene sulfide film, polypropylene film, polyimide film and cellophane. The polyester film is frequently used at present from general point of views including mechanical, electrical, physical and chemical properties and processibility. A biaxially stretched polyethylene terephthalate (PET) film is frequently used among them.

A transparent resin and transparent ceramic may be used as the substrate 1 as well as the plastic films exemplified above. Pigments and dyes may be added therein. The substrate 1 may be a film or plate, and may be thick enough to lose its flexibility, or enough to have a strength required for the substrate 1.

The substrate 1 used in the invention is preferably a plastic film having a thickness in the range of 50 to 200 μm, and more preferably a PET film having a thickness in the range of 80 to 200 μm.

On the surface of the substrate 1, for instance, an image receiving layer is provided on one surface thereof, and function control layers such as glossiness control layer, light fastness control layer, and the like are preferably provided on the other surface, in accordance with the necessity.

According to the invention, on a surface of the substrate 1 as mentioned above, an image is formed according to an electrophotographic process. The image formation according to the electrophotographic process is carried out as follows.

On a surface of an electrophotographic photosensitive body that is disposed in image forming apparatus, electric charges are uniformly given to electrify the surface, thereafter, image-wise light corresponding to image information is irradiated on the surface and thereby an electrostatic latent image is formed. Subsequently, onto the electrostatic latent image on the surface of the electrophotographic photosensitive body, a toner is supplied from a developing device, thereby the electrostatic latent image is visualized by means of the toner, that is, a toner image is formed. Furthermore, the formed toner image is transferred directly, or via an intermediate transferring body, on the substrate 1. Finally the toner image is fixed on the substrate 1 by use of heat and/or pressure, and thereby a fixed image 2 is formed. When a full-color image is formed, operations before the fixing step are carried out for, in general, each of four colors of yellow, magenta, cyan and black. The obtained toner images (toner layers) of the respective colors are successively laminated directly on the substrate 1 or successively laminated on the intermediate transferring body followed by the transfer of the toner layers on the substrate 1, and thereby fixed on the substrate 1.

In the image forming process in the FIG. 2, four toner image forming portions of W (white color) 14W, C (cyan) 14C, M (magenta) 14M, and Y (yellow) 14Y are disposed along a belt-like intermediate transferring body 6. Owing to a movement of the intermediate transferring body 6 in the direction shown by the arrow mark, a primary transfer is repeated, and thereby a primary transfer image 5 is formed on a surface of the intermediate transferring body 6. Thereafter, by use of a secondary transfer roll, the primary transfer image 5 is secondarily transferred on the surface of the substrate 1, and thereby a secondary transfer image 6 is formed on the surface of the substrate 1.

In the secondary transfer image 6, toner layers are laminated in the order reverse to that in the primary transfer image 5. For instance, in FIG. 2, portions 7 where Y, M, C and W are successively laminated from a surface of the substrate 1 and portions 8 where one layer of W or M is formed on the surface of the substrate 1 are mixed. That is, in the toner image (fixed image) in the invention, all of the toner image may be constituted by a plurality of toner layers or the toner image may partially include portions composed of a single toner layer.

On the other hand, when the light screening property of, for instance, the image portion is demanded, sufficiently low light-transmitting property cannot be secured with the toners of the four colors of Y (yellow), C (cyan), M (magenta) and K (black) as mentioned above. That is because a toner mass of developable K color is limited in that case. So, it is preferable to form a toner layer having a sufficient mass of the K colored toner on the substrate 1 and to secure the screening property of the light non-transmitting portion, not by developing each of four colors of Y, C, M and K once, but by developing the K color twice to form a toner image having two layers of the K colored toner.

A method of forming an image by the electrophotographic process as mentioned above is not particularly limited. Methods, processes, apparatus, and means so far known as electrophotographic techniques can be adopted without problems.

The toner for electrophotography that is used in the invention includes, as main components, a binding resin and a coloring agent.

Examples of the binding resin used for the toner include homopolymers or copolymers of:

styrenes such as styrene and chlorostyrene;

monoolefins such as ethylene, propylene, butylene and isobutylene;

vinyl esters such as vinyl acetate, vinyl propionate, vinyl benzoate and vinyl acetate;

α-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate; vinyl ethers such as vinylmethyl ether, vinylethyl ether and vinylbutyl ether; and

vinyl ketones such as vinylmethyl ketone, vinylhexyl ketone and vinylisopropenyl ketone. Examples of the representative binding resins include polystyrene, styrene-acrylic ester copolymers, styrene-methacrylic ester acid copolymers, styrene-acrylonitrile copolymers, styrene-butadiene copolymers, styrene-maleic anhydride copolymers, polyethylene and polypropylene.

Additional examples of the binding resin include polyester, polyurethane, epoxy resins, silicone resins, polyamide, modified rosins, paraffin and wax. Polyester is particularly suitable as the binding resin among the resins above. The polyester resin used in the invention is synthesized by polycondensation of a polyol component and an acid component. Examples of the polyol component include ethyleneglycol, propyleneglycol, 1,3-butanediol, 1,4-butanediol, 2,3-butanediol, diethylene glycol, triethylene glycol, 1,5-butanediol, 1,6-hexanediol, neopentyl glycol, cyclohexane dimethanol, bisphenol A/ethylene oxide adducts, and bisphenol A/propylene oxide adducts.

Examples of the acid component include maleic acid, fumaric acid, phthalic acid, isophthalic acid, terephthalic acid, succinic acid, dodecenyl succinic acid, trimellitic acid, pyrromellitic acid, cyclohexane tricarboxylic acid, 1,5-cyclohexane dicarboxylic acid, 2,5,7-naphthalene tricarboxylic acid, 1,2,4-naphthalene tricarboxylic acid, 1,2,5-hexane tricarboxylic acid and 1,3-dicarboxyl-2-methylenecarboxypropane tetramethylene carboxylic acid, and anhydrides thereof. A plurality of resins selected from the resins above may be blended.

The melting temperatures of toners of the respective layers of the plurality of toner layers can be controlled by varying mainly a kind, composition, molecular weight and the like of the binding resin used for the toner.

The molecular weight of the binding resin of the toner is preferably in the range of 10² to 10⁶ in terms of weight average molecular weight, and more preferably in the range of 10³ to 10⁵.

While representative examples of the representative coloring agents include carbon black as a black coloring agent; C.I. pigment red 48:1, C.I. pigment red 122, and C.I. pigment red 57:1 as magenta coloring agents; C.I. pigment yellow 97, C.I. pigment yellow 12, and C.I. pigment yellow 180 as yellow coloring agents; and C.I. pigment blue 15:1 and C.I. pigment blue 15:3 as cyan coloring agents, the coloring agents are not restricted thereto.

While the examples of the white coloring agent include titanium oxide, silica, tin oxide, aluminum oxide and magnesium oxide, titanium oxide is preferable from the viewpoint of the light resistance. While rutile type, anatase type and brookite type titanium oxides are known as titanium oxide, rutile type titanium oxide is preferable from the viewpoint of the screening property. The surface of titanium oxide is preferably surface-treated with alumina or silica in order to improve the light resistance.

In the case where an image portion constituted of the respective toners of magenta, yellow, cyan and white color is displayed with a backlight, a certain degree of transparency is demanded; that is, a transmission density is preferably in the range of 0.1 to 1, and more preferably in the range of 0.3 to 0.7. Accordingly, a content of the coloring agent in the toner is preferably in the range of 4 to 40% by mass, and more preferably in the range of 6 to 35% by mass. Furthermore, a transferred mass per unit area, TMA, of the toners on a surface of the substrate 1 is preferably in the range of 0.3 to 1.0 mg/cm².

On the other hand, in the case of an image portion where the K (black) toner is used and the screening property of light is required, a high transmission density is required. In order to heighten the transmission density, a content of carbon black, which is a coloring agent, may be increased or the TMA of the black toner may be increased. However, since the carbon black is electrically conductive, too much addition of the carbon black to the toner causes a decrease in the electric resistance of the toner. As a result, a charging quantity decreases, resulting in fogging and scattering of the toner. Furthermore, since resistance of a developer also decreases, carriers themselves are developed and white spots are generated in the image, resulting in image quality defect (BCO), which is generation of white spots in the image. Furthermore, when the TMA is too high, the transfer onto the substrate 1 becomes insufficient, resulting in image unevenness. In order to realize high transmission density without causing fogging, toner scattering, BCO and image unevenness, a content of carbon black is preferably in the range of 4 to 15% by mass and a TMA of the black toner is preferably in the range of 1.2 to 2.0 mg/cm².

The toner for electrophotography that is used in the invention may contain known additives such as an antistatic agent, wax and the like, in accordance with the necessity. Usable antistatic agents include azo-based metal complexes and metal complexes or metal salts of salicylic acid or alkyl salicylic acid. Usable waxes include olefinic waxes such as low molecular weight polyethylene and low molecular weight polypropylene, plant-derived waxes such as carnauba, and various waxes such as animal-derived waxes, ore-derived waxes.

While the method for producing the electrophotographic toner used in the invention is not particularly restricted, for example, a melt-pulverization method is preferable. According to the melt-pulverization method, various toner materials as described above are mixed with a Banbury mixer, Nyder coater, continuous mixer and extruder, and melt-kneaded, pulverized and classified to produce toner. The volume average particle diameter of the toner is 30 μm or less, preferably in the range of 4 to 20 μm.

A fluidizing agent may be further added in the electrophotographic toner used in the invention as a separate component. Examples of the fluidizing agent include silica, titanium oxide and aluminum oxide.

The electrophotographic toner used in the invention may be used as a two-component developer by mixing with an appropriate carrier. Any carrier known in the art may be used. For example, the carriers usable include ferrite, magnetite and iron powders, and the surface thereof may be coated with a resin such as a styrene resin, fluorinated resin, silicone resin or epoxy resin. It is possible to use the carrier as a semiconductive or conductive carrier by adding a conductive powder such as carbon black or a metal oxide powder to the coating resin. The volume average particle diameter of the carrier is usually adjusted in the range of 20 to 100 μm.

The mass mixing ratio of the toner in the two-component developer controls the amount of electrification of the toner, determines the upper limit of the amount of the developing toner, and is an important factor that determines TMA. The mixing ratio is adjusted in the range of 2 to 12% by mass in the invention. Desired TMA cannot be easily obtained when the mixing ratio is smaller than 2% by mass, since the amount of electrification becomes too high or the upper limit of the amount of the developing toner becomes small. Fogging and scattering of the toner are sometimes easily occur when the mixing ratio is larger than 12% by mass since the electrification quantity is too low.

The plurality of toner layers on a surface of the substrate 1 can be fixed by being heated and melted by, for instance, a fixing device 20 incorporated in the image forming apparatus 10. In the fixing, a roll-type fixing device may be used or a belt-type fixing device may be used.

When a plurality of toner layers are formed by using the above described substrate and toners in such a manner that the toner melting temperature of the outermost toner layer may be the highest followed by fixing as mentioned above, a blister-free and pinhole-free image-recorded medium according to the invention can be obtained.

### EXAMPLES

In the following, the present invention will be detailed by showing examples. However, the invention is not restricted to these examples. In the following, “parts” means “parts by mass”, unless specified otherwise.

### Example 1

<Preparation of Substrate>

Preparation of Coating Solution for Glossiness Control layer

To 100 parts of butyl alcohol, 10 parts of polyvinyl butyral (manufactured by Sekisui Chemical Co., Ltd.: BM-S) as a heat meltable resin, 15 parts of polymethyl methacrylate fine particles (manufactured by Soken Chemical & Engineering Co., Ltd.: MP-1451, volume average particle diameter: 0.1 μm) as a filler and 0.5 parts of anti-static agent (manufactured by Nippon Oil & Fats Co., Ltd.: ELEGAN 264 WAX) were added followed by thorough mixing with a homomixer, thereby a coating solution A for glossiness control layer was prepared.

Preparation of Coating Solution for Image Receiving Layer

A coating solution B for image receiving layer was prepared, wherein the coating solution B for image receiving layer had the same composition as that of the coating solution A for glossiness control layer except that the filler was removed and 0.05 parts of crosslinked polymethyl methacrylate fine particles (manufactured by Soken Chemical & Engineering Co., Ltd.: MP-150, volume average particle diameter: 5 μm) was added as a matting agent.

Preparation of Substrate

The coating solution A for glossiness control layer was coated on a PET film having a thickness of 125 μm (Manufactured by Panac Ltd.: Lumilar 125T60) in an amount of 30 g/m², dried at 130° C. for 10 minutes, thereby a glossiness control layer having a film thickness of 2 μm was formed. Furthermore, the coating solution B for image receiving layer was similarly coated on the surface of the PET film on the side opposite to the glossiness control layer side, to form an image receiving layer having a film thickness of 2 μm. Thereby a substrate that is used in the invention was prepared.

<Preparation of Image-Recorded Medium>

The four toner layers of W (white, toner melting temperature: 140° C.), C (cyan, toner melting temperature: 130° C.), M (magenta, toner melting temperature: 120° C.), and Y (yellow, toner melting temperature: 110° C.)—colored toners were primarily developed in the order of W, C, M, and Y by using Color Docutech 60 (manufactured by Fuji Xerox Co., Ltd.) having four developing units (toner image forming parts) as an electrophotographic image forming apparatus.

A TMA of the toner layers before fixing was 2.3 mg/cm². Thereafter, the toner layers were fixed at 150° C. by the developing device.

The image on the obtained image-recorded medium was a high-quality image not accompanied by image quality defects such as inferior graininess and observable dots.

<Evaluation of Image-Recorded Medium>

When the image-recorded medium thus prepared was set on a light table and illuminated with a fluorescent lamp from a rear side, no pinholes transmitting the light from the fluorescent lamp were observed with the naked eye. Thereby, it was confirmed that the OHP sheet had excellent quality.

In the next place, the image-recorded medium was once more put into an oven and subjected to the heat resistant test at 90° C. for 1000 hr. The image-recorded medium was also evaluated in the similar manner to that described above. Similarly, no pinholes and voids transmitting the light from the fluorescent lamp were observed. Thereby, it was confirmed that the image maintained high-quality.

### Comparative Example 1

An image-recorded medium was prepared in the same manner as that in Example 1, except that the toners used in the developing units all had the same melting temperature of 100° C. The obtained image-recorded medium was evaluated in the similar manner to that in Example 1.

In the prepared image-recorded medium, even in its initial state, several pinholes were observable with the naked eye. Thereby, it was confirmed that the OHP had inferior image quality.

As is obvious from the results, in the image-recorded medium in which the melting temperature of the toner that constitutes at least the outermost toner layer was set the highest among those of other layers (example 1), the air in the toner layers were more efficiently excluded during the fixing and generation of pinholes or voids were more strongly suppressed, in comparison with the image-recorded medium manufactured without any control on the melting temperatures of the toners in the respective toner layers (comparative example 1).

The example was explained by using an OHP sheet. However, the application of the invention is not limited to the Example and can also be applied to other uses such as display panels of home appliance such as an electronic oven and a display board of a measuring instrument.

According to the invention, an image-recorded medium having a highly reliable recording image can be provided.

What is claimed is:

1. An image-recorded medium comprising a fixed image obtained by electrophotographically laminating a plurality of toner layers on a transparent substrate and fixing the plurality of toner layers, wherein a toner constituting at least an outermost toner layer has the highest melting temperature among toners constituting the respective layers of the plurality of toner layers.

2. An image-recorded medium according to claim 1, wherein the lowest melting temperature among the toners constituting the respective layers of the plurality of toner layers is at least 80° C.

3. An image-recorded medium according to claim 1, wherein the plurality of toner layers includes two layers of K (black) colored toner.

4. An image-recorded medium according to claim 1, wherein the plurality of toner layers includes a K (black) colored toner layer, and a black toner in the K colored toner layer contains 4 to 15% by mass of carbon black and has a TMA of 1.2 to 2.0 mg/cm².

5. An image-recorded medium according to claim 1, wherein each of the plurality of toner layers includes a carrier having a particle diameter of 20 to 100 μm and the toner, and a ratio of a mass of the toner to a total mass of the carrier and the toner is from 2 to 12%.

6. An image-recorded medium according to claim 1, wherein a TMA of the toners on a surface of the substrate is from 0.3 to 1.0 mg/cm².

7. An image-recorded medium according to claim 1, wherein the plurality of toner layers includes toner layers of magenta color, yellow color, cyan color and white color, and the respective toner layers each include toners comprising 4 to 40% by mass of a coloring agent.

8. An image-recorded medium according to claim 1, wherein a difference between melting temperature of the toner of the outermost toner layer and the melting temperatures of toners of other layer having different melting temperatures are from 5 to 30° C.

9. An image-recorded medium according to claim 8, wherein the lowest melting temperature of the toners each constituting one of the plurality of toner layers is at least 80° C.

10. An image-recorded medium according to claim 1, wherein a melting temperature of the toner constituting each of the plurality of toner layers sequentially increases from a first layer formed on a surface of the substrate toward the outermost toner layer.

11. An image-recorded medium according to claim 10, wherein the lowest melting temperature of the toners constituting the respective layers of the plurality of toner layers is at least 80° C.

12. An image-recorded medium according to claim 10, wherein the plurality of toner layers includes two layers of K (black) colored toner.

13. An image-recorded medium according to claim 10, wherein the plurality of toner layers includes a K (black) colored toner layer, and a black toner in the K colored toner layer contains 4 to 15% by mass of carbon black and has a TMA of 1.2 to 2.0 mg/cm².

14. An image-recorded medium according to claim 10, wherein each of the plurality of toner layers includes a carrier having a particle diameter of 20 to 100 μm and the toner, and a ratio of a mass of the toner to a total mass of the carrier and the toner is from 2 to 12%.

15. An image-recorded medium according to claim 10, wherein a TMA on a surface of the substrate is from 0.3 to 1.0 mg/cm².

16. An image-recorded medium according to claim 10, wherein the plurality of toner layers includes toner layers of magenta color, yellow color, cyan color and white color, and the respective toner layers each include a toner comprising 4 to 40% by mass of a coloring agent.

17. An image-recorded medium according to claim 10, wherein a difference between a melting temperature of the toner of the outermost toner layer and the melting temperatures of toners of other layers having different melting temperatures are from 5 to 30° C.

18. An image-recorded medium according to claim 17, wherein the lowest melting temperature of the toners each constituting one of the plurality of toner layers is at least 80° C.
